(19) United States
(12) Patent Application Publication
(10) Pub. No.: US 2015/0351175 A1
(43) Pub. Date: Dec. 3, 2015

(54) FEEDBACK CIRCUIT, CONTROL CIRCUIT, AND POWER SUPPLY APPARATUS INCLUDING THE SAME

(71) Applicant: SAMSUNG ELECTRO-MECHANICS CO., LTD., Suwon-Si (KR)

(72) Inventors: Won Young LEE, Suwon-Si (KR); Hee Seo Lee, Suwon-Si (KR); Hyo Young Kim, Suwon-Si (KR); Sung Hun Oh, Suwon-Si (KR)

(73) Assignee: SAMSUNG ELECTRO-MECHANICS CO., LTD., Suwon-Si (KR)

(21) Appl. No.: 14/625,614

(22) Filed: Feb. 18, 2015

(30) Foreign Application Priority Data
Jun. 3, 2014 (KR) 10-2014-0067457

(51) Int. Cl. H05B 33/08

(52) U.S. Cl. CPC H05B 33/0815

(57) ABSTRACT

A feedback circuit includes a detection voltage regulating unit outputting a regulation voltage by comparing a detection voltage associated with a current flowing in a light emitting diode channel with a reference voltage, a path forming unit forming a current path depending on the regulation voltage, and a feedback signal generating unit generating a feedback signal depending on a current flowing in the current path.

### CROSS-REFERENCE TO RELATED APPLICATION

This application claims the priority and benefit of Korean Patent Application No. 10-2014-0067457, filed on Jun. 3, 2014, with the Korean Intellectual Property Office, the disclosure of which is incorporated in its entirety herein by reference.

### BACKGROUND

Some embodiments of the present disclosure may relate to a feedback circuit, a control circuit, and a power supply apparatus including the same.

In existing liquid crystal display (LCD) devices, cold cathode fluorescent lamps (CCFLs) have mainly been used as backlight light sources. However, recently, light emitting diodes (LEDs) have gradually been used as backlight light sources, due to various advantages thereof, such as low power consumption, relatively long lifespans, and environmentally-friendly characteristics.

In order to drive the LEDs, a power supply circuit for converting alternating current (AC) power into direct current (DC) power and a driving circuit controlling the supply of the DC power to the LEDs may be used.

Such a power supply circuit may be divided into a primary side circuit and a secondary side circuit, on the basis of a transformer, in order to enhance an insulation function. For example, the primary side circuit may be configured to rectify and smooth commercial AC power and switch the power, while the secondary side circuit may be configured to rectify the power transformed by the transformer and drive a load.

That is, in general, the primary side circuit may be provided with a power switching control circuit, and the secondary side circuit may be provided with the above-mentioned driving circuit. Generally, the secondary side circuit may include a DC/DC converting unit and use a scheme of driving the LEDs by transforming the power transferred from the transformer.

However, in a case in which the LEDs are driven by boosting or dropping the voltage of the power transferred from the transformer, manufacturing costs of the power supply circuit maybe increased and a volume of the power supply circuit may be increased.

### Related Art Document

(Patent Document 1) Korean Patent Laid-Open Publication No. 10-2010-0134944

### SUMMARY

Some exemplary embodiments in the present disclosure may provide a feedback circuit, a control circuit, and a power supply apparatus including the same, which may be able to remove a converter provided in a secondary side of a transformer.

According to an exemplary embodiment in the present disclosure, a feedback circuit may include: a detection voltage regulating unit outputting a regulation voltage by comparing a detection voltage associated with a current flowing in a light emitting diode channel with a reference voltage; a path forming unit forming a current path depending on the regulation voltage; and a feedback signal generating unit generating a feedback signal depending on a current flowing in the current path.

According to an exemplary embodiment in the present disclosure, a control circuit of a power converting circuit may supply an output voltage to a light emitting diode channel connected to an output terminal in a secondary side which is electrically insulated from a primary side by alternately switching an input voltage input to the primary side. The control circuit may include: a feedback unit including a detection voltage regulating unit outputting a regulation voltage by comparing a detection voltage associated with a current flowing in the light emitting diode channel with a reference voltage, a path forming unit forming a current path depending on the regulation voltage, and a feedback signal generating unit generating a feedback signal depending on a current flowing in the current path; and a switching controlling unit generating a control signal controlling a switching operation of input power depending on the feedback signal.

According to an exemplary embodiment in the present disclosure, a power supply apparatus may include: a power converting unit supplying an output voltage to a light emitting diode channel connected to an output terminal in a secondary side which is electrically insulated from a primary side by alternately switching an input voltage input to the primary side; and a controlling unit including a feedback unit and a switching controlling unit. The feedback unit may include a detection voltage regulating unit outputting a regulation voltage by comparing a detection voltage associated with a current flowing in the light emitting diode channel with a reference voltage, a path forming unit forming a current path depending on the regulation voltage, and a feedback signal generating unit generating a feedback signal depending on a current flowing in the current path, and the switching controlling unit generating a control signal controlling a switching operation of input power depending on the feedback signal. The power converting unit may convert the input voltage into the output voltage using a resonance-type power converting scheme.

### BRIEF DESCRIPTION OF THE DRAWINGS

The above and other aspects, features and advantages of the present disclosure will be more clearly understood from the following detailed description taken in conjunction with the accompanying drawings, in which:

FIG. 1 is a diagram schematically illustrating a power supply apparatus according to an exemplary embodiment in the present disclosure;

FIG. 2 is a diagram illustrating a power converting unit employed in a power supply apparatus according to an exemplary embodiment in the present disclosure;

FIG. 3 is a diagram illustrating a controlling unit employed in a power supply apparatus according to an exemplary embodiment in the present disclosure;

FIG. 4 is a diagram illustrating an example of a feedback unit employed in a power supply apparatus according to an exemplary embodiment in the present disclosure;

FIGS. 5 and 6 are diagrams illustrating examples of a feedback unit employed in a power supply apparatus according to exemplary embodiments in the present disclosure; and

FIG. 7 is a diagram illustrating a switching controlling unit employed in a power supply apparatus according to an exemplary embodiment in the present disclosure.

### DETAILED DESCRIPTION

Exemplary embodiments of the present disclosure will now be described in detail with reference to the accompanying drawings.

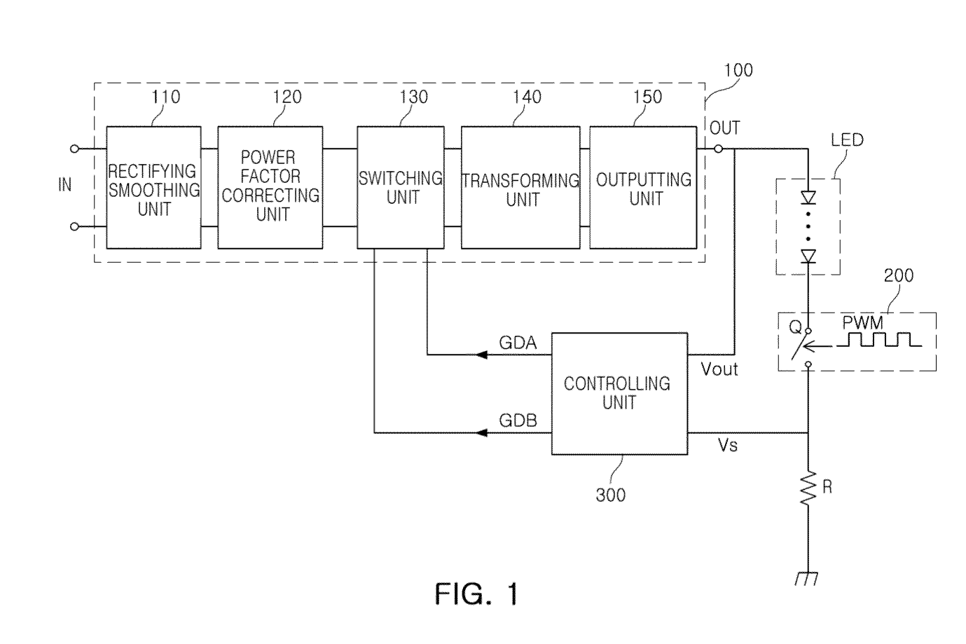

FIG. 1 is a diagram schematically illustrating a power supply apparatus according to an exemplary embodiment in the present disclosure. Referring to FIG. 1, a power supply apparatus according an exemplary embodiment may include a power converting unit 100 and a controlling unit (a control circuit) 300.

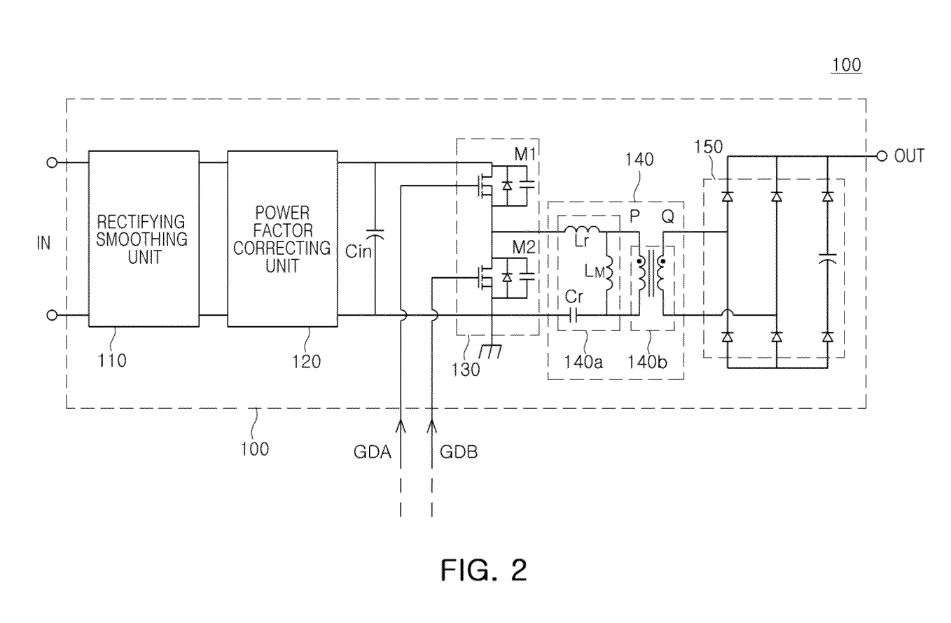

FIG. 2 is a diagram illustrating details of the power converting unit 100 employed in the power supply apparatus according to an exemplary embodiment in the present disclosure. The power converting unit 100 according to the present exemplary embodiment will be described with reference to FIG. 2.

The power converting unit 100 may include a switching unit 130, a transforming unit 140, and an outputting unit 150. The power converting unit 100 further include a rectifying smoothing unit 110 and a power factor correcting unit 120.

The rectifying smoothing unit 110 may rectify and smooth alternating current (AC) power input to an input terminal IN to generate direct current (DC) power and transfer the DC power to the power factor correcting unit 120. The power factor correcting unit 120 may correct a power factor, for example, but not limited to, by regulating a phase difference between a voltage and a current of the power transferred from the rectifying smoothing unit 110.

The switching unit 130 may include at least two switches M1 and M2. The switches M1 and M2 maybe stacked between a node, to which the DC power from the power factor correcting unit 120 is input, and a ground. The switching unit 130 may perform a power converting operation by an alternate switching operation of the switch M1 and the switch M2.

The transforming unit 140 may include a resonance tank 140a and a transformer 140b. The resonance tank 140a may provide an inductor-inductor-capacitor (Lr-Lm-Cr) (LLC) resonance operation. Here, one inductor Lm of the LLC may be, for instance, but not limited to, a magnetizing inductor of the transformer 140b.

The transformer 140b may include a primary winding P and a secondary winding Q. The primary winding P and the secondary winding Q may be electrically insulated from each other. That is, the primary winding P and the secondary winding Q may differ in electrical properties of the ground.

More specifically, the rectifying smoothing unit 110, the power factor correcting unit 120, the switching unit 130, the resonance tank 140a, and the primary winding P of the transformer 140b may be provided in the primary side, and the secondary winding Q of the transformer 140b and the outputting unit 150 may be provided in the secondary side.

The primary winding P and the secondary winding Q may form a preset turns ratio, and the secondary winding Q may vary a voltage level depending on the turns ratio to output power having the varied voltage level.

The outputting unit 150 may rectify and stabilize the power received in the secondary winding Q to output an output voltage Vout to an output terminal OUT. Here, the output voltage Vout may be supplied to a load connected to the output terminal OUT, for example, but not limited to, at least one light emitting diode (LED) channel.

Referring to FIG. 1, a dimming unit 200 may include a switch Q connected to an end of the LED channel. The switch Q may control a current flowing in the LED channel and regulate brightness of light output from the LED channel by performing a switching operation in response to a pulse width modulation (PWM) signal provided by a PWM integrated circuit (IC) (not illustrated).

The controlling unit 300 may generate control signals GDA and GDB depending on the output voltage Vout and a voltage Vs associated with a current flowing in the LED channel. The control signals GDA and GDB may be provided to at least two switches M1 and M2 employed in the switching unit 130, respectively. The current flowing in the LED channel may be detected as a detection voltage Vs by a resistor R connected to the end of the LED channel.

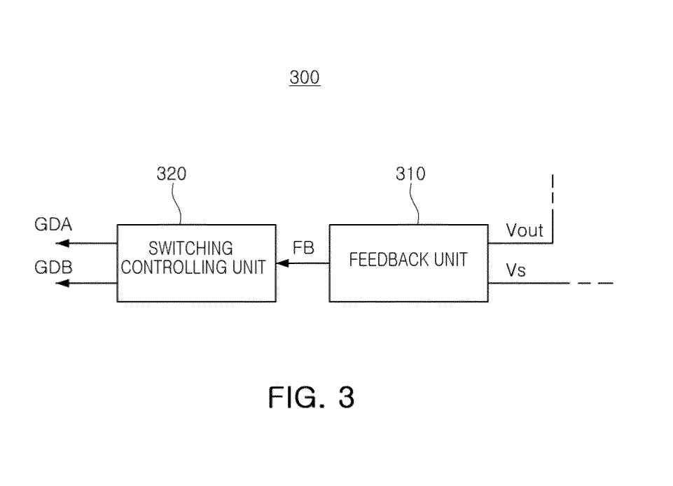

FIG. 3 is a diagram illustrating an example of a controlling unit employed in a power supply apparatus according to an exemplary embodiment in the present disclosure. Referring to FIG. 3, the controlling unit 300 may include a feedback unit 310 and a switching controlling unit 320.

The feedback unit 310 may generate a feedback signal FB by receiving the output voltage Vout and the detection voltage Vs. The feedback unit 310 may determine a voltage level of the feedback signal FB depending on a level of the detection voltage Vs and may provide the generated feedback signal FB to the switching controlling unit 320.

The switching controlling unit 320 may generate the control signals GDA and GDB depending on the feedback signal FB provided from the feedback unit 310. In this case, frequencies of the control signals GDA and GDB may be set depending on the voltage level of the feedback signal FB.

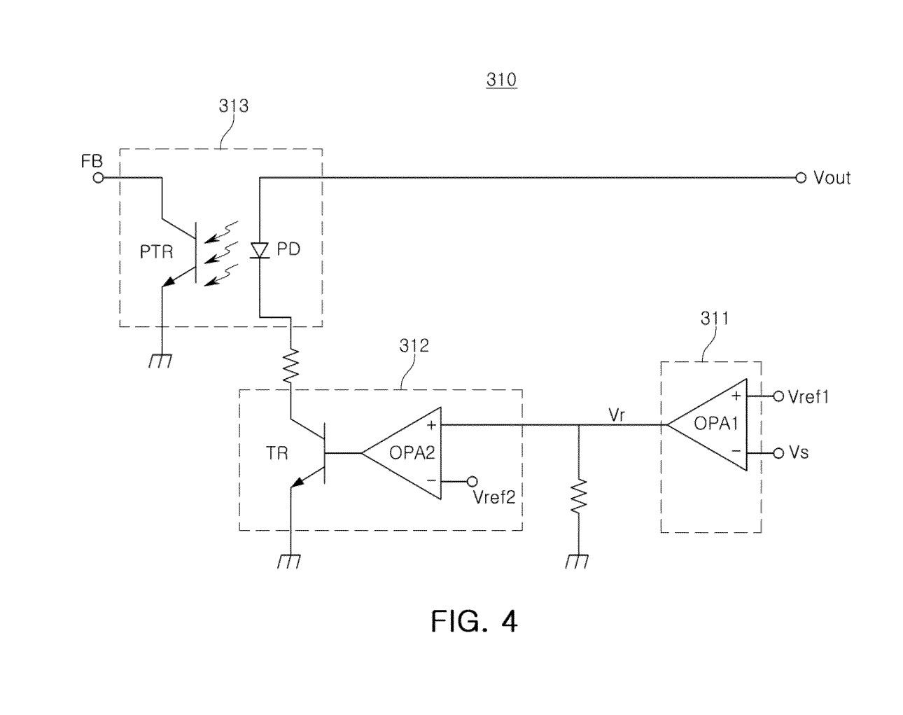

FIG. 4 is a diagram illustrating an example of a feedback unit employed in a power supply apparatus according to an exemplary embodiment in the present disclosure.

The feedback unit 310 may include a detection voltage regulating unit 311, a path forming unit 312, and a feedback signal generating unit 313.

The detection voltage regulating unit 311 may compare a detection voltage Vs with a first reference voltage Vref1 and may output a regulation voltage Vr depending on the comparison result. The detection voltage regulating unit 311 may include a first operational amplifier OPA1. The detection voltage Vs may be applied to an inverting terminal of the first operational amplifier OPA1 and the first reference voltage Vref1 may be applied to a non-inverting terminal of the first operational amplifier OPA1. The regulation voltage Vr generated or outputted from the detection voltage regulating unit 311 may be provided to the path forming unit 312.

The path forming unit 312 may form a current path depending on the regulation voltage Vr. The path forming unit 312 may include a second operational amplifier OPA2 and a transistor TR. The regulation voltage Vr may be applied to a non-inverting terminal of the second operational amplifier OPA2, and a second reference voltage Vref2 may be applied to an inverting terminal of the second operational amplifier OPA2, such that the second operational amplifier OPA2 may output an output voltage depending on a comparison result through an output terminal thereof. In the present embodiment, the output terminal of the second operational amplifier OPA2 may be connected to a controlling terminal of the transistor TR.

For example, the transistor TR may include a heterojunction bipolar transistor (BJT). The BJT may have abase connected to the output terminal of the second operational amplifier OPA2, an emitter connected to a ground, and a collector connected to the feedback signal generating unit 313.

The feedback signal generating unit 313 may include a photo-coupler. The photo-coupler may include a photodiode PD emitting light by voltages applied to both ends thereof and a phototransistor PTR performing a switching on/off operation by the light emitted from the photodiode PD. The output voltage Vout may be applied to an anode of the photodiode PD and a voltage induced into the collector of the transistor TR may be applied to a cathode of the photodiode PD. The phototransistor PTR may output the feedback signal FB, and a voltage level of the feedback signal FB output from the phototransistor PTR may be varied depending on a current flowing in the photodiode PD.

An amount of a current flowing in the transistor TR and the photodiode PD may be determined or changed depending on a level of the regulation voltage Vr input to the second operational amplifier OPA2 of the path forming unit 312. In a case in which the regulation voltage Vr is lower than the second reference voltage Vref2, the feedback signal FB of a high voltage level may be output from the feedback signal generating unit 313. In a case in which the regulation voltage Vr is higher than the second reference voltage Vref2, the feedback signal FB of a low voltage level may be output from the feedback signal generating unit 313.

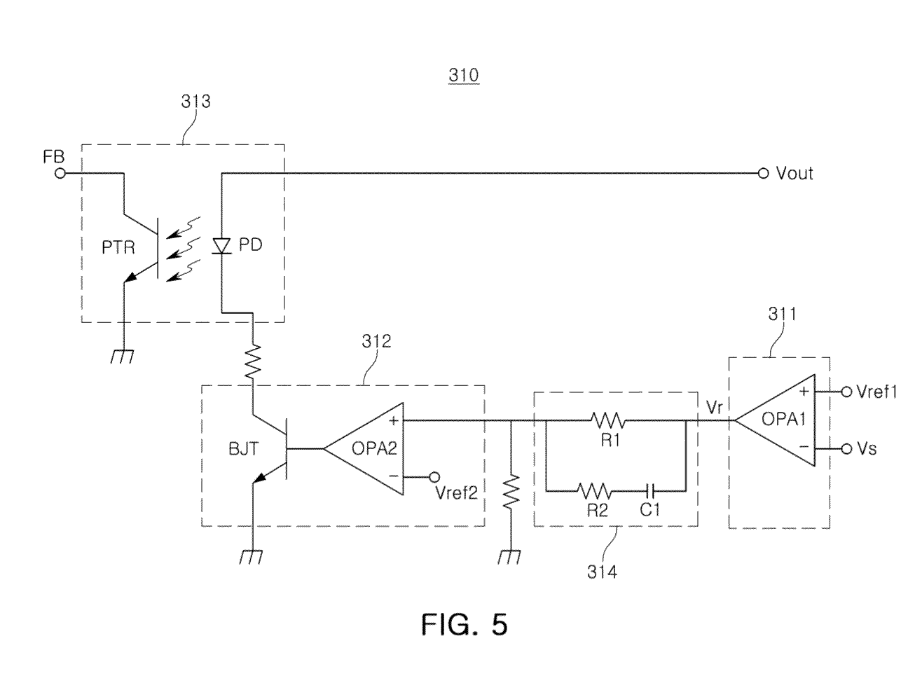

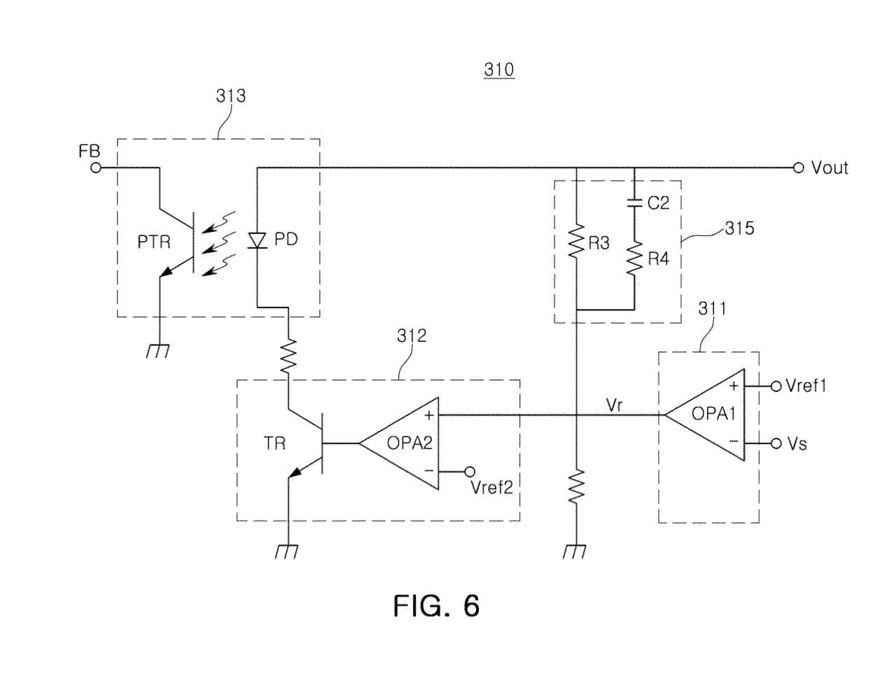

FIGS. 5 and 6 are diagrams illustrating examples of a feedback unit employed in a power supply apparatus according to exemplary embodiments in the present disclosure.

Referring to FIG. 5, the feedback unit 310 of FIG. 5 may include the detection voltage regulating unit 311, the path forming unit 312, the feedback signal generating unit 313, and a stabilizing unit 314. Since the detection voltage regulating unit 311, the path forming unit 312, and the feedback signal generating unit 313 are similar to those described in the embodiment of FIG. 4, the descriptions thereof will be omitted in order to avoid redundancy and details of the stabilizing unit 314 will be mainly provided.

The stabilizing unit 314 may be disposed between the detection voltage regulating unit 311 and the path forming unit 312. The stabilizing unit 314 may include a first resistor R1, a second resistor R2 and a first capacitor C1. The second resistor R2 and the first capacitor C1 may be connected to each other in series and disposed in parallel to the first resistor R1.

The regulation voltage Vr output from the detection voltage regulating unit 311 may be affected by the detection voltage Vs. The detection voltage Vs may include a peak voltage component which may be generated at a turn on/off operation timing of the switch Q connected to the end of the LED channel. The stabilizing unit 314 may remove the peak voltage component of the detection voltage Vs which may be reflected in the regulation voltage Vr.

Next, referring to FIG. 6, the feedback unit 310 may include the detection voltage regulating unit 311, the path forming unit 312, the feedback signal generating unit 313, and a compensating unit 315.

The compensating unit 315 may be disposed between the anode of the photodiode PD and a connection node between the detection voltage regulating unit 311 and the path forming unit 312. The compensating unit 315 may include a third resistor R3, a fourth resistor R4 and a second capacitor C2. The fourth resistor R4 and the second capacitor C2 may be connected to each other in series and disposed in parallel to the third resistor R3.

In a case in which a load level of the LED channel connected to the output terminal OUT is sharply changed, the regulation voltage Vr may not follow the level of the output voltage Vout. In this case, the compensating unit 315 may compensate for a level difference between the output voltage Vout and the regulation voltage Vr.

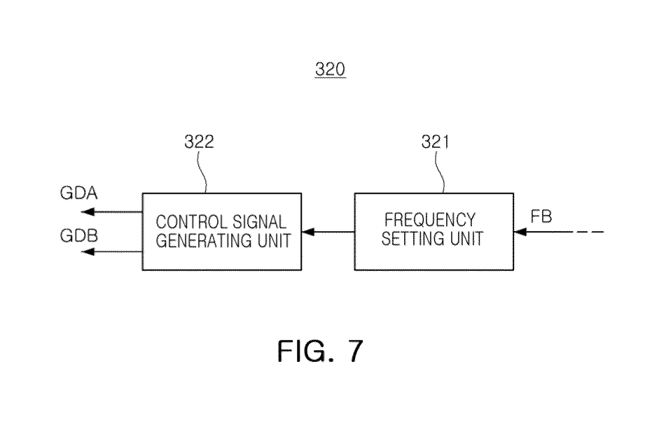

FIG. 7 is a diagram illustrating a switching controlling unit employed in a power supply apparatus according to an exemplary embodiment in the present disclosure. The switching controlling unit 320 may include a frequency setting unit 321 and a control signal generating unit 322.

The frequency setting unit 321 may determine the frequencies of the control signals depending on the voltage level of the feedback signal FB. For example, the frequency setting unit 321 may set a high frequency level in a case in which the voltage level of the feedback signal FB is high, and may set a low frequency level in a case in which the voltage level of the feedback signal FB is low, but not limited thereto.

The control signal generating unit 322 may generate the control signals GDA and GDB corresponding to the frequency level set by the frequency setting unit 321. In a case in which the frequency levels of the control signals GDA and GDB are high, the level of the output voltage Vout may be decreased. In a case in which the frequency levels of the control signals GDA and GDB are low, the level of the output voltage Vout may be increased.

As set forth above, according to some exemplary embodiments, the converter provided in the secondary side of the transformer may be removed from the feedback circuit, the control circuit, and the power supply apparatus including the same, whereby manufacturing costs of the power supply apparatus may be reduced and the volume of the power supply apparatus may be reduced.

While exemplary embodiments have been shown and described above, it will be apparent to those skilled in the art that modifications and variations could be made without departing from the scope of the invention as defined by the appended claims.

What is claimed is:

1. A feedback circuit, comprising:
a detection voltage regulating unit outputting a regulation voltage by comparing a detection voltage, associated with a current flowing in a light emitting diode channel, with a first reference voltage;
a path forming unit forming a current path depending on the regulation voltage; and
a feedback signal generating unit generating a feedback signal depending on a current flowing in the current path.

2. The feedback circuit of claim 1, wherein the detection voltage regulating unit includes:
an inverting terminal to which the detection voltage is applied;
a non-inverting terminal to which the first reference voltage is applied; and
an output terminal from which the regulation voltage is output.

3. The feedback circuit of claim 1, wherein the path forming unit includes:
a operational amplifier including a non-inverting terminal to which the regulation voltage is applied and an inverting terminal to which a second reference voltage is applied; and
a transistor forming the current path and including a controlling terminal connected to an output terminal of the operational amplifier.

4. The feedback circuit of claim 3, wherein the transistor includes a heterojunction bipolar transistor, and
the heterojunction bipolar transistor has a base connected to the output terminal of the operational amplifier, an emitter connected to a ground, and a collector connected to the feedback signal generating unit.

5. The feedback circuit of claim 4, wherein the feedback signal generating unit includes:
a photo-coupler having a photodiode emitting light depending on the current flowing in the current path; and
a phototransistor performing a switching operation depending on the light emitted from the photodiode to output the feedback signal.

6. The feedback circuit of claim 5, wherein the photodiode includes:
a cathode connected to the path forming unit; and
an anode to which an output voltage is applied.

7. The feedback circuit of claim 1, further comprising a stabilizing unit removing a peak voltage component of the regulation voltage.

8. The feedback circuit of claim 7, wherein the stabilizing unit includes:
a first resistor disposed between the detection voltage regulating unit and the path forming unit; and
a second resistor and a first capacitor connected to each other in series and connected in parallel to the first resistor.

9. The feedback circuit of claim 6, further comprising a compensating unit disposed between the anode of the photodiode and a connection node between the detection voltage regulating unit and the path forming unit,
wherein the compensating unit includes:
a third resistor; and
a fourth resistor and a second capacitor connected to each other in series and connected in parallel to the third resistor.

10. A control circuit of a power converting circuit supplying an output voltage to a light emitting diode channel connected to an output terminal in a secondary side which is electrically insulated from a primary side by alternately switching an input voltage input to the primary side, the control circuit comprising:
a feedback unit including a detection voltage regulating unit outputting a regulation voltage by comparing a detection voltage, associated with a current flowing in the light emitting diode channel, with a first reference voltage, a path forming unit forming a current path depending on the regulation voltage, and a feedback signal generating unit generating a feedback signal depending on a current flowing in the current path; and
a switching controlling unit generating a control signal controlling a switching operation of input power depending on the feedback signal.

11. The control circuit of claim 10, wherein the detection voltage regulating unit includes:
an inverting terminal to which the detection voltage is applied;
a non-inverting terminal to which the first reference voltage is applied; and
an output terminal from which the regulation voltage is output.

12. The control circuit of claim 10, wherein the path forming unit includes:
a operational amplifier including a non-inverting terminal to which the regulation voltage is applied and an inverting terminal to which a second reference voltage is applied; and
a transistor forming the current path and including a controlling terminal connected to an output terminal of the operational amplifier.

13. The control circuit of claim 12, wherein the transistor includes a heterojunction bipolar transistor, and
the heterojunction bipolar transistor has a base connected to the output terminal of the operational amplifier, an emitter connected to a ground, and a collector connected to the feedback signal generating unit.

14. The control circuit of claim 13, wherein the feedback signal generating unit includes:
a photo-coupler having a photodiode emitting light depending on the current flowing in the current path; and
a phototransistor performing a switching operation depending on the light emitted from the photodiode to output the feedback signal.

15. The control circuit of claim 14, wherein the photodiode includes:
a cathode connected to the path forming unit; and
an anode to which the output voltage is applied.

16. The control circuit of claim 10, wherein the switching controlling unit sets a frequency level of the control signal in proportional to a voltage level of the feedback signal.

17. A power supply apparatus, comprising:
a power converting unit supplying an output voltage to a light emitting diode channel connected to an output terminal in a secondary side which is electrically insulated from a primary side by alternately switching an input voltage input to the primary side; and
a controlling unit including a feedback unit and a switching controlling unit,
the feedback unit including a detection voltage regulating unit outputting a regulation voltage by comparing a detection voltage associated with a current flowing in the light emitting diode channel with a first reference voltage, a path forming unit forming a current path depending on the regulation voltage, and a feedback signal generating unit generating a feedback signal depending on a current flowing in the current path, and the switching controlling unit generating a control signal controlling a switching operation of input power depending on the feedback signal,
wherein the power converting unit converts the input voltage into the output voltage using a resonance-type power converting scheme.

18. The power supply apparatus of claim 17, further comprising a dimming unit connected to an end of the light emitting diode channel and regulating the current flowing in the light emitting diode channel.
